(19) United States
(12) Patent Application Publication
(10) Pub. No.: US 2025/0172943 A1
(43) Pub. Date: May 29, 2025

(54) METHOD, APPARATUS AND PROGRAM FOR OBSTACLE AVOIDANCE CONTROL OF SERVING ROBOT

(71) Applicant: RGT Inc., Seoul (KR)

(72) Inventor: Hojeong JEONG, Daejeon (KR)

(73) Assignee: RGT Inc., Seoul (KR)

(21) Appl. No.: 18/952,721

(22) Filed: Nov. 19, 2024

(30) Foreign Application Priority Data
Nov. 29, 2023 (KR) 10-2023-0169561

(51) Int. Cl. G05D 1/622; G05D 1/246; G05D 105/28; G05D 107/40

(52) U.S. Cl. CPC G05D 1/622; G05D 1/246; G05D 2105/28; G05D 2107/40

(57) ABSTRACT

A method of obstacle avoidance control of a serving robot according to various embodiments of the present invention is disclosed. The method may include: generating optimal paths for each of a plurality of tables included in a space in which the serving robot performs serving based on map information on the space; when serving for a specific table is set, transmitting a specific optimal path for moving to a target point corresponding to the specific table to the serving robot and controlling the serving robot to move to the target point through the specific optimal path; and when the serving robot recognizes an obstacle while moving to the target point and stops moving, controlling the serving robot to wait and then move to the target point through the specific optimal path or move to the target point through an avoidance path.

### CROSS-REFERENCE TO RELATED APPLICATION

This application claims priority to and the benefit of Korean Patent Application No. 10-2023-0169561, filed on Nov. 29, 2023, the disclosure of which is incorporated herein by reference in its entirety.

### BACKGROUND

### 1. Field of the Invention

The present invention relates to a method, apparatus, and program for obstacle avoidance control of a serving robot, and more particularly, to a method, apparatus, and program for controlling a serving robot to move to a target point using an avoidance path or using an existing optimal path after waiting depending on a situation in which the serving robot recognizes obstacles.

### 2. Discussion of Related Art

Serving means providing objects such as drinks or food to customers in places such as restaurants. Recently, serving robots, etc., have been developed and are being used to serve instead of waiters or waitresses or to assist waiters or waitresses.

These serving robots usually have a function of receiving food orders or performing serving according to orders, and may also autonomously drive using table location information, etc. Such serving robots may include a unit of transportation (including a sensor for avoiding obstacles), a display unit for outputting menus or accepting orders, etc.

In addition, a robot may include a unit for arranging or transporting food or food containers.

Meanwhile, the conventional serving robot control algorithm is set to load ordered food from a table and transport the ordered food to the corresponding table, and returns to an original return point when customers at the corresponding table receive the food loaded on the serving robot.

When there are a plurality of serving robots that are on the move, if each serving robot calculates the shortest distance when the plurality of serving robots are driving without considering the movement of the other serving robots, there is a possibility of a collision between the serving robots.

In such a case, when serving robots simply stop to avoid a collision with other serving robots while driving along the calculated path, serving efficiency may decrease or the plurality of serving robots may get stuck in a deadlock, resulting in a situation where the plurality of serving robots have to wait indefinitely.

Therefore, research is being conducted on various control methods that allow a serving robot to avoid obstacles without decreasing serving efficiency. In this regard, Korean Laid-Open Patent No. 10-2023-0122349 discloses a method of collision avoidance control of a mobile robot based on a virtual obstacle.

### SUMMARY OF THE INVENTION

The present invention is directed to providing a method, an apparatus, and a program for obstacle avoidance control of a serving robot.

However, aspects of the present invention are not restricted to those set forth herein. The above and other aspects of the present invention will become more apparent to one of ordinary skill in the art to which the present invention pertains by referencing the detailed description of the present invention given below.

According to an aspect of the present invention for solving the above-described problems, a method of obstacle avoidance control of a serving robot is disclosed. The method may include: generating optimal paths for each of a plurality of tables included in a space in which the serving robot performs serving based on map information on the space; when serving for a specific table is set, transmitting a specific optimal path for moving to a target point corresponding to the specific table to the serving robot and controlling the serving robot to move to the target point through the specific optimal path; and when the serving robot recognizes an obstacle while moving to the target point and stops moving, controlling the serving robot to wait and then move to the target point through the specific optimal path or move to the target point through an avoidance path.

The generating of the optimal paths for each of the plurality of tables included in the space in which the serving robot performs serving based on the map information on the space may includes generating one or more optimal paths corresponding to congestion levels for each of the plurality of tables according to one or more congestion levels, and the one or more congestion levels may be determined based on at least one of a current time, the number of orders placed in the space, and the number of people who have entered the space.

When the serving for the specific table is set, the transmitting of the specific optimal path for moving to the target point corresponding to the specific table to the serving robot and the controlling of the serving robot to move to the target point through the specific optimal path includes: recognizing a current congestion level based on information on the number of orders and the number of people received from at least one of the serving robot, a user terminal, and an external server, and the current time; and transmitting the specific optimal path corresponding to the current congestion level among one or more optimal paths for the specific table to the serving robot.

When the serving for the specific table is set, the transmitting of the specific optimal path for moving to the target point corresponding to the specific table to the serving robot and the controlling of the serving robot to move to the target point through the specific optimal path includes: when there are two or more accessible target points on the specific table because at least two surfaces of the specific table are in contact with a passage, recognizing movement paths of other serving robots; and controlling the serving robot to move to the target point through the specific optimal path that has a least overlapping path with the movement paths of the other serving robots among the optimal paths corresponding to each of the two or more target points.

When the serving robot recognizes the obstacle while moving to the target point and stops moving, the controlling of the serving robot to wait and then move to the target point through the specific optimal path or move to the target point through the avoidance path includes: recognizing an area of a passage corresponding to a section on which the obstacle is recognized; calculating a variable area by applying a weight corresponding to the congestion level to the area of the passage; and controlling the serving robot to wait and then move to the target point through the specific optimal path when the variable area is less than a preset size and move to the target point through the avoidance path when the variable area is greater than or equal to the preset size.

When the serving robot recognizes the obstacle while moving to the target point and stops moving, the controlling of the serving robot to wait and then move to the target point through the specific optimal path or move to the target point through the avoidance path includes: when the obstacle is the other serving robot, recognizing a target point of the other serving robot; and when the target point of the other serving robot is a return point, controlling the serving robot to wait so that the other serving robot is first movable and then move to the target point through the specific optimal path.

When the serving robot recognizes the obstacle while moving to the target point and stops moving, the controlling of the serving robot to wait and then move to the target point through the specific optimal path or move to the target point through the avoidance path includes: when the obstacle is the other serving robot, recognizing a table of the other serving robot; when the target point of the other serving robot is not a return point, generating an avoidance path between a current position of the serving robot and the specific table; predicting a first movement time for the serving robot to wait for a time for the other serving robot to deviate from a section recognized as the obstacle from the current position and then move to the target point through the specific optimal path; predicting a second movement time for the serving robot to move from the current position to the specific table through the avoidance path; and determining a movement path for controlling the serving robot based on the first movement time and the second movement time and controlling the serving robot to move to the target point through the determined movement path.

When the serving robot recognizes the obstacle while moving to the target point and stops moving, the controlling of the serving robot to wait and then move to the target point through the specific optimal path or move to the target point through the avoidance path includes: when the obstacle is not another serving robot, recognizing whether movement is detected in the obstacle and generating an avoidance path between a current position of the serving robot and a target point corresponding to the specific table; when movement is detected in the obstacle, predicting a first movement time for the serving robot to wait for a preset time at the current position and then move to the target point through the specific optimal path; predicting a second movement time for the serving robot to move from the current position to the specific table through the avoidance path; and determining a movement path for controlling the serving robot based on the first movement time and the second movement time and controlling the serving robot to move to the target point through the determined movement path.

According to an aspect of the present invention for solving the above-described problem, an apparatus is disclosed. The apparatus includes: a memory configured to store one or more instructions; and a processor configured to execute the one or more instructions stored in the memory, in which the processor may perform the above-described methods by executing the one or more instructions.

Another aspect of the present disclosure provides a computer-readable recording medium. The computer-readable recording medium may provide a surgery simulation method in combination with a computer which is hardware.

Other details of the present invention are described in a detailed description and are illustrated in the drawings.

### BRIEF DESCRIPTION OF DRAWINGS

FIG. 1 is a diagram illustrating a system according to an embodiment of the present invention.

FIGS. 2 and 3 are exemplary diagrams illustrating a serving robot applicable to various embodiments.

FIG. 4 is a diagram illustrating a hardware configuration of a computing device that performs a method of obstacle avoidance control of a serving robot according to an embodiment of the present invention.

FIGS. 5 to 7 are diagrams for describing an example of the method of obstacle avoidance control of a serving robot according to an embodiment of the present invention.

### DETAILED DESCRIPTION OF EXEMPLARY EMBODIMENTS

Hereinafter, various embodiments will be described with reference to the drawings. In this specification, various descriptions are presented to provide an understanding of the invention. However, it is obvious that these embodiments may be practiced without these specific descriptions.

The terms “component,” “module,” “system,” etc., used herein refer to a computer-related entity, hardware, firmware, software, a combination of software and hardware, or an implementation of software. For example, a component may be, but is not limited to, a procedure running on a processor, a processor, an object, an execution thread, a program, and/or a computer. For example, both an application running on a computing device and the computing device may be a component. One or more components may reside within a processor and/or execution thread. One component may be localized within one computer. One component may be distributed between two or more computers. In addition, these components may be executed from various computer-readable media having various data structures stored therein. Components may communicate via local and/or remote processes (e.g., data from one component interacting with other components in a local system and a distributed system and/or data transmitted to other systems via networks such as the Internet through signals), for example according to signals with one or more data packets.

In addition, the term “or” is intended to mean an inclusive “or,” not an exclusive “or.” That is, unless otherwise specified or clear from context, “X uses A or B” is intended to mean one of the natural implicit substitutions. That is, “X uses A or B” may apply to any of the cases in which X uses A, X uses B, or X uses both A and B. In addition, the term “and/or” used herein should be understood to refer to and include all possible combinations of one or more of the related items listed.

In addition, the terms “include” and/or “including” should be understood to mean that the corresponding feature and/or component is present. However, the terms “include” and/or “including” should be understood as not excluding the presence or addition of one or more other features, components and/or groups thereof. In addition, unless otherwise specified or the context clearly indicates a singular form, the singular form in the present specification and in the claims should generally be construed to mean “one or more.”

In addition, those skilled in the art should recognize that various illustrative logical blocks, configurations, modules, circuits, means, logic, algorithms, and steps described in connection with the embodiments disclosed herein may be implemented by electronic hardware, computer software, or a combination of both. To clearly illustrate interchangeability of hardware and software, various illustrative components, blocks, configurations, means, logics, modules, circuits, and steps have been described above generally in terms of their functionality. Whether such functionality is implemented by hardware or software will depend on the specific application and design constraints imposed on the overall system. Those skilled in the art may implement the described functionality in a variety of ways for each specific application. However, such implementation determinations should not be construed as departing from the scope of the present invention.

The description of the presented embodiments is provided to enable those skilled in the art to make or use the present invention. Various modifications to these embodiments will be apparent to those skilled in the art. The general principles defined herein may be applied to other embodiments without departing from the scope of the invention. Therefore, the present invention is not limited to the embodiments presented herein. The present invention should be interpreted in the broadest scope consistent with the principles and novel features presented herein.

In this specification, a computer is any kind of hardware device including at least one processor, and can be understood as including a software configuration which is operated in the corresponding hardware device according to the embodiment. For example, the meaning of “computer” may be understood to include all of smart phones, tablet PCs, desktops, laptops, and user clients and applications running on each device, but is not limited thereto.

Hereinafter, embodiments of the present invention will be described in detail with reference to the accompanying drawings.

Each step described in this specification is described as being performed by the computer, but subjects of each step are not limited thereto, and according to embodiments, at least some of each step can also be performed on a different device.

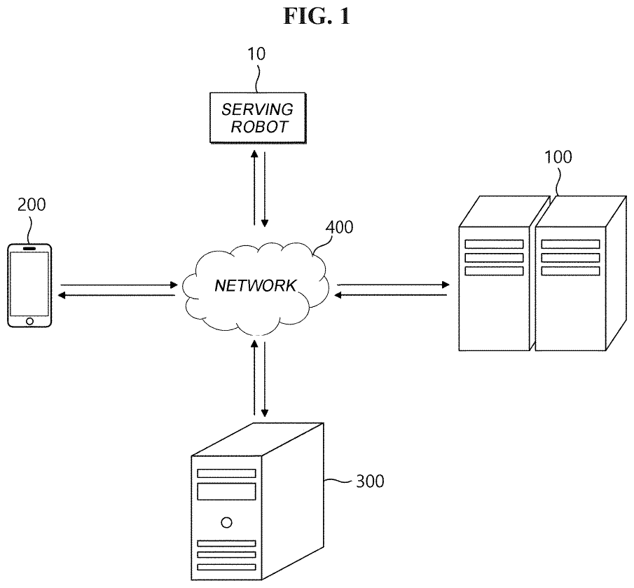

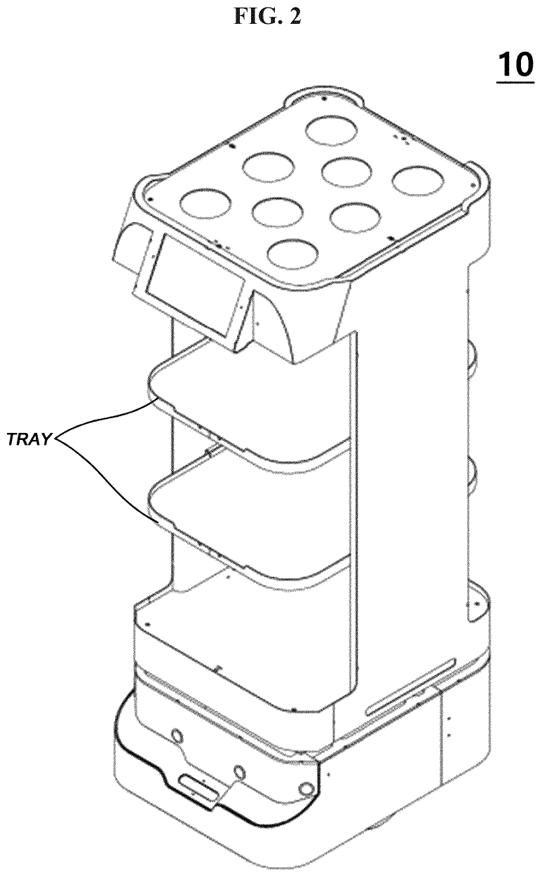

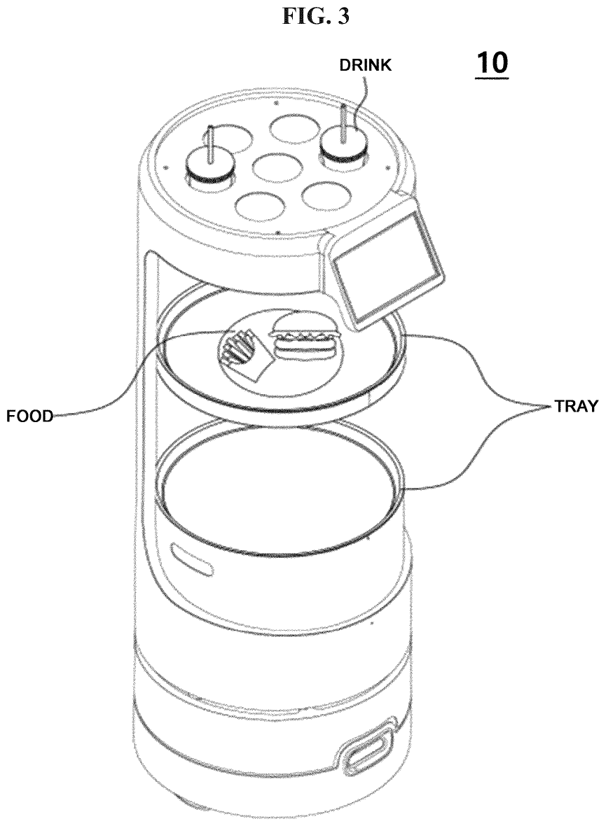

FIG. 1 is a diagram illustrating a system according to an embodiment of the present invention. FIGS. 2 and 3 are exemplary diagrams illustrating a serving robot applicable to various embodiments.

Referring to FIG. 1, the system according to the embodiment of the present invention may include a serving robot 10, a computing device 100, a user terminal 200, and an external server 300. Here, the system illustrated in FIG. 1 is according to an embodiment, and components of the system are not limited to the embodiment illustrated in FIG. 1, and may be added, changed, or omitted as necessary.

In an embodiment, the computing device 100 may control various operations of the serving robot 10. For example, the computing device 100 may be connected to the serving robot 10 through a network 400, and may determine a control command (e.g., a control command for instructing movement along a specific path, a control command for instructing waiting for a predetermined time, and a control command for instructing returning to a preset return point, etc.) for controlling the operation of the serving robot 10, and may control the operation of the serving robot 10 according to the determined control command.

In an embodiment, the computing device 100 may perform a method of obstacle avoidance control of a serving robot.

Specifically, the computing device 100 may generate optimal paths for each of a plurality of tables included in a space in which the serving robot 10 performs serving based on map information on the space. In addition, when serving for a specific table is set, the computing device 100 may transmit a specific optimal path to the serving robot 10 for moving to a target point corresponding to the specific table to control the serving robot 10 to move to the target point through the specific optimal path. In addition, when the serving robot 10 recognizes an obstacle while moving to the target point and stops moving, the computing device 100 may control the serving robot 10 to wait and then move to the target point through the specific optimal path or to move to the target point through an avoidance path.

For example, the computing device 100 may control the serving robot 10 in a method with the highest serving efficiency (for example, a method with the fastest moving time) depending on the situation in which the serving robot 10 recognizes an obstacle.

Therefore, the computing device 100 of the present invention may control the serving robot to avoid an obstacle while increasing the serving efficiency.

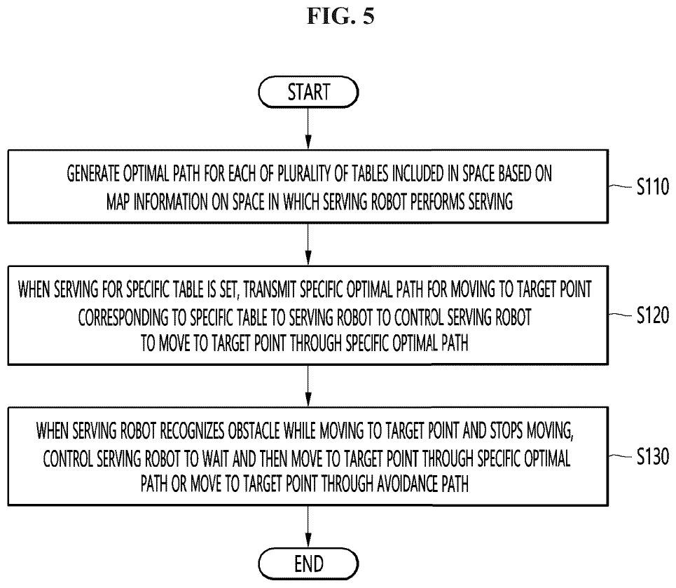

Hereinafter, an example in which the computing device 100 provides the method of obstacle avoidance control of a serving robot will be described with reference to FIGS. 5 to 7.

In an embodiment, the serving robot 10 may operate according to a control command acquired from the computing device 100. Here, the serving robot 10 may be implemented in a form that transports food to a specific table according to the control command acquired from the computing device 100. For example, the serving robot 10 may include a tray for loading food as illustrated in FIGS. 2 and 3, and may be implemented in a movable form, such as including wheels (not illustrated) at the bottom, but is not limited thereto.

In various embodiments, the serving robot 10 may include a sensor module (not illustrated).

The sensor module may generate sensor data by scanning an area near the serving robot 10. For example, the sensor module may include a camera sensor that generates image data by capturing images in a direction in which the serving robot 10 is moving.

In addition, the sensor module may further include a weight measurement sensor that measures a weight value of the tray of the serving robot 10. However, the present invention is not limited thereto.

In an embodiment, the user terminal 200 may be connected to the computing device 100 through the network 400, and may receive a user interface (UI) from the computing device 100.

The user may receive various types of information (e.g., control results of the serving robot 10, such as an operating status of the serving robot 10 and a driving path, etc.) through the UI provided through the computing device 100.

In addition, the user may directly control the serving robot 10 through the UI provided through the computing device 100.

Here, the user terminal 200 may be a terminal of a manager (e.g., a store user), but is not limited thereto, and may be a device installed in the store (e.g., a point of sale system (POS) installed at the store counter, etc.).

In addition, here, the user terminal 200 may be any type of entity(s) in the system that has a mechanism for communication with the computing device 100. For example, the user terminal 200 may include a personal computer (PC), a notebook, a mobile terminal, a smart phone, a tablet PC, a wearable device, etc., and may include all types of terminals that may access wired/wireless networks. In addition, the user terminal 200 may include any computing device implemented by at least one of an agent, an application programming interface (API), and a plug-in. In addition, the user terminal 200 may include an application source and/or a client application.

In an embodiment, the external server 300 is connected to the computing device 100 through the network 400, and may store and manage information and data required for the computing device 100 to perform various processes, or may receive, store, and manage information and data generated as the computing device 100 performs various processes. For example, the external server 300 may be a storage server separately provided outside the computing device 100, but is not limited thereto.

In an embodiment, the network 400 may be a connection structure capable of exchanging information between respective nodes such as a plurality of terminals and servers. For example, the network 400 may include a local area network (LAN), a wide area network (WAN), the Internet (World Wide Web (WWW)), a wired/wireless data communication network, a telephone network, a wired/wireless television communication network, a controller area network (CAN), Ethernet, or the like.

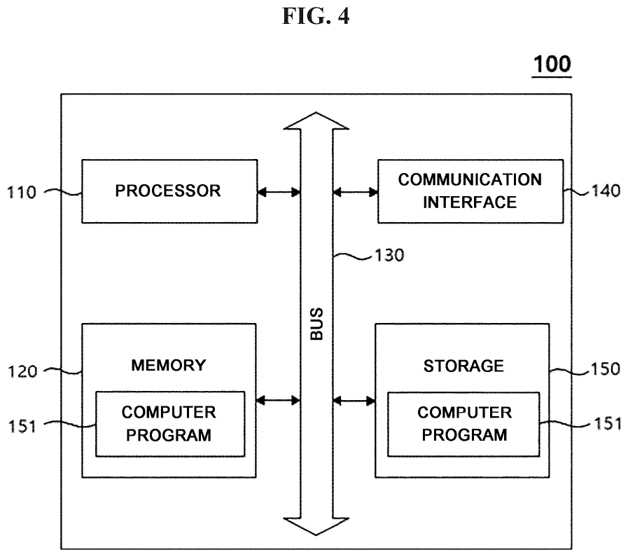

Examples of the wireless data communication network may include 3G, 4G, 5G, 3^{rd} Generation Partnership Project (3GPP), 5^{th} Generation Partnership Project (5GPP), Long Term Evolution (LTE), World Interoperability for Microwave Access (WiMAX), Wi-Fi, Internet, a LAN, a wireless LAN (WLAN), a WAN, a personal area network (PAN), radio frequency, a Bluetooth network, a near-field communication (NFC) network, a satellite broadcast network, an analog broadcast network, a digital multimedia broadcasting (DMB) network, and the like, but are not limited thereto. Hereinafter, a hardware configuration of the computing device 100 will be described with reference to FIG. 4.

FIG. 4 is a diagram illustrating a hardware configuration of a computing device that performs a method of obstacle avoidance control of a serving robot according to an embodiment of the present invention.

Referring to FIG. 4, according to various embodiments, the computing device 100 according to an embodiment of the present invention may include one or more processors 110, a memory 120 that loads a computer program 151 executed by the processor 110, a bus 130, a communication interface 140, and a storage 150 that stores the computer program 151. Here, only the components related to the embodiment of the present invention are illustrated in FIG. 4. Accordingly, those skilled in the art to which the present invention pertains may understand that general-purpose components other than those illustrated in FIG. 4 may be further included.

The processor 110 controls an overall operation of each component of the computing device 100. The processor 110 may include a central processing unit (CPU), a micro processor unit (MPU), a micro controller unit (MCU), a graphics processing unit (GPU), or any type of processor well known in the art of the present invention.

In addition, the processor 110 may perform an operation on at least one application or program for executing the method according to the embodiments of the present invention, and the computing device 100 may include one or more processors.

In various embodiments, the processor 110 may further include a random access memory (RAM) (not illustrated) and a read-only memory (ROM) (not illustrated) for temporarily and/or permanently storing signals (or data) processed in the processor 110. In addition, the processor 110 may be implemented in the form of a system-on-chip (SoC) including at least one of a graphics processing unit, a RAM, and a ROM.

The memory 120 stores various data, commands, and/or information. The memory 120 may load the computer program 151 from the storage 150 to execute methods/operations according to various embodiments of the present invention. When the computer program 151 is loaded into the memory 120, the processor 110 may perform the method/operation by executing one or more instructions constituting the computer program 151. The memory 120 may be implemented as a volatile memory such as a RAM, but the technical scope of the present invention is not limited thereto.

The bus 130 provides a communication function between the components of the computing device 100. The bus 130 may be implemented as various types of buses, such as an address bus, a data bus, and a control bus.

The communication interface 140 supports wired/wireless Internet communication of the computing device 100. In addition, the communication interface 140 may support various communication manners other than the Internet communication. To this end, the communication interface 140 may include a communication module well known in the art of the present invention. In some embodiments, the communication interface 140 may be omitted.

The storage 150 may non-temporarily store the computer program 151. When performing the method of obstacle avoidance control of a serving robot through the computing device 100, the storage 150 may store various types of information necessary to provide the method of obstacle avoidance control of a serving robot.

The storage 150 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present invention pertains.

The computer program 151 may include one or more instructions to cause the processor 110 to perform methods/operations according to various embodiments of the present invention when loaded into the memory 120. That is, the processor 110 may perform the method/operation according to various embodiments of the present invention by executing the one or more instructions.

In an embodiment, the computer program 151 may include one or more instructions for causing the method of obstacle avoidance control of a serving robot to be performed, the method including generating an optimal path for each of the plurality of tables included in a space in which the serving robot 10 performs serving based on map information on the space, when the serving for the specific table is set, transmitting a specific optimal path for moving to a target point corresponding to the specific table to the serving robot 10 and controlling the serving robot 10 to move to the target point through the specific optimal path, and when the serving robot 10 recognizes an obstacle while moving to the target point and stops moving, controlling the serving robot 10 to wait and then move to the target point through the specific optimal path or move to the target point through the avoidance path.

Operations of the method or algorithm described with reference to the embodiment of the present invention may be directly implemented in hardware, in software modules executed by hardware, or in a combination thereof. The software module may reside in a RAM, a ROM, an erasable programmable ROM (EPROM), an electrically erasable programmable ROM (EEPROM), a flash memory, a hard disk, a removable disk, a compact disc ROM (CD-ROM), or in any form of computer-readable recording media known in the art to which the invention pertains.

The components of the present invention may be embodied as a program (or application) and stored in media for execution in combination with a computer which is hardware. The components of the present invention may be executed in software programming or software elements, and similarly, embodiments may be realized in a programming or scripting language such as C, C++, Java, and assembler, including various algorithms implemented in a combination of data structures, processes, routines, or other programming constructions. Functional aspects may be implemented in algorithms executed on one or more processors. Hereinafter, the method of obstacle avoidance control of a serving robot performed by the computing device 100 will be described with reference to FIGS. 5 to 7.

FIGS. 5 to 7 are diagrams for describing an example of the method of obstacle avoidance control of a serving robot according to an embodiment of the present invention.

Referring to FIG. 5, the computing device 100 may generate optimal paths for each of the plurality of tables included in the space in which the serving robot 10 performs serving based on map information on the space (S110).

Specifically, the computing device 100 may generate one or more optimal paths corresponding to the congestion levels for each of the plurality of tables according to one or more congestion levels.

For example, the computing device 100 may determine one or more congestion levels and generate one or more optimal paths to correspond to each of the one or more congestion levels. For example, in the case where the computing device 100 determines one or more congestion levels in units of 10, it may generate 10 optimal paths for each of the plurality of tables included in the space.

In an embodiment, the computing device 100 may generate the optimal paths for each of the plurality of tables through a shortest path calculation algorithm so that the serving robot 10 may serve food through the shortest path within the space according to the map information. For example, the computing device 100 may generate the optimal paths for each of the plurality of tables using a graph search algorithm such as the Dijkstra algorithm or the A* algorithm, but is not limited thereto.

In various embodiments, when the computing device 100 generates as many optimal paths for each of the plurality of tables as the number of one or more congestion levels, the computing device 100 may add virtual obstacles having different numbers or sizes according to one or more congestion levels within the space according to the map information, and then generate the optimal paths for each of the plurality of tables through the shortest path calculation algorithm.

For example, when the congestion level is 1, the computing device 100 may generate a first optimal path along which movement to each of the plurality of tables is possible while adding one virtual obstacle within the space. In addition, when the congestion level is 2, which is greater than 1, the computing device 100 may generate a second optimal path along which movement to each of the plurality of tables is possible while adding two virtual obstacles in the space. In this case, the first optimal path and the second optimal path may have different paths.

In an embodiment, one or more congestion levels may be metrics used to evaluate the congestion situation of the space where the serving robot 10 operates (e.g., a restaurant). In addition, one or more congestion levels may be determined based on at least one of the current time, the number of orders placed in the space, and the number of people who have entered the space.

Specifically, the computing device 100 may determine at least one of a first indicator corresponding to the time at which the serving robot 10 performs serving, a second indicator corresponding to the number of orders placed in the space, and a third indicator corresponding to the number of people who have entered the space, and determine one or more congestion levels based on the determined indicator.

For example, the computing device 100 may apply different values related to the first indicator depending on a preset time period. For example, the computing device 100 may apply, as the values related to the first indicator, 1 point to a morning time period, 2 points to a time period from noon to 6 p.m., 3 points to a time period from 6 p.m. to 8 p.m. and 2 points to a time period from 8 p.m. to midnight.

In addition, the computing device 100 may apply different values related to the second indicator corresponding to the number of orders placed in the space depending on the number of workers working in the space. For example, the computing device 100 may apply, as the values related to the second indicator, 1 point to the number of orders corresponding to 1 times the number of workers or more but less than 2 times the number of workers, 2 points to the number of orders corresponding to 2 times the number of workers or more but less than 3 times the number of workers, 3 points to the number of orders corresponding to 3 times the number of workers or more but less than 4 times the number of workers, and 4 points to the number of orders corresponding to 4 times the number of workers or more.

In addition, the computing device 100 may apply different values related to the third indicator corresponding to the number of people who have entered the space depending on the total number of seats provided in the space. For example, the computing device 100 may apply, as the values related to the third indicator, 1 point to the number of people corresponding to less than 30% of the total number of seats provided in the space, 2 points to the number of people corresponding to 30% or more but less than 60% of the total number of seats provided in the space, 3 points to the number of people corresponding to 60% or more but less than 90% of the total number of seats provided in the space, and 4 points to the number of people corresponding to 90% or more of the total number of seats provided in the space.

In an additional embodiment, a plurality of other serving robots may exist in the space in which the serving robot 10 of the present invention performs serving. In this case, the computing device 100 may collect information for determining the congestion levels from the serving robot 10 and each of the plurality of other serving robots.

For example, the computing device 100 may additionally use an indicator for acquiring images from the serving robot 10 and each of the plurality of other serving robots and calculating the congestion levels based on the number of people or the number of obstacles present within an image having a preset frame size.

In an embodiment, when the computing device 100 determines the scores to be applied to each of the first indicator corresponding to the time for performing the serving, the second indicator corresponding to the number of orders placed in the space, and the third indicator corresponding to the number of people who have entered the space, the computing device 100 may recognize the scores that can be calculated by adding or averaging the scores related to the first indicator, the second indicator, and the third indicator. In addition, the computing device 100 may generate optimal paths corresponding to each of the scores that can be calculated for each of the plurality of tables included in the space.

For example, when the computing device 100 adds the scores corresponding to each indicator, the computing device 100 may divide the calculable scores into 3 points to 11 points and congestion levels into 9 stages. In this case, the computing device 100 may generate 9 optimal paths for each of the plurality of tables included in the space.

Meanwhile, the computing device 100 may determine the congestion level based on the current situation of the space in operation (S120) to be described below and transmit a specific optimal path corresponding to the congestion level to the serving robot 10, so that the computing device 100 may control the serving robot 10 to move along the specific optimal path.

When the serving for the specific table is set, the computing device 100 may transmit the specific optimal path to the serving robot 10 for moving to the target point corresponding to the specific table to control the serving robot 10 to move to the target point through the specific optimal path.

For example, when an item ordered at a specific table is prepared, the computing device 100 may transmit the specific optimal path for moving to the target point corresponding to the specific table to the serving robot 10 and control the serving robot 10 to move to the target point through the specific optimal path.

In an embodiment, the specific optimal path may be determined according to the congestion level of the space in which the serving robot 10 performs serving.

Specifically, the computing device 100 may recognize the current congestion level based on the information on the number of orders and the number of people received from at least one of the serving robot 10, the user terminal 200, and the external server 300, and the current time. In addition, the computing device 100 may transmit the specific optimal path corresponding to the current congestion level among one or more optimal paths for the specific table to the serving robot 10.

For example, when the computing device 100 determines the scores for each section of the first indicator, the second indicator, and the third indicator for determining the congestion level in the operation (S110) described above, the computing device 100 may recognize the scores for each section corresponding to the current number of orders, the number of people, and the time for each indicator. In addition, the computing device 100 may determine the congestion level based on the scores for each indicator. In addition, the computing device 100 may transmit the specific optimal path corresponding to the determined congestion level to the serving robot 10.

According to various embodiments, as at least two surfaces of the specific table are in contact with the passage, there may be two or more accessible target points on a specific table.

In this case, the computing device 100 may recognize the movement paths of other serving robots. In addition, the computing device 100 may control the serving robot 10 to move to the target point through the specific optimal path that has the least overlapping path with the movement paths of other serving robots among the optimal paths corresponding to each of the two or more target points.

In an embodiment, after operation (S120), when the serving robot 10 recognizes an obstacle while moving to the target point and stops moving, the computing device 100 may control the serving robot 10 to wait and then move to the target point through the specific optimal path or to move to the target point through the avoidance path (S130).

In an embodiment, the computing device 100 may acquire the current position of the serving robot 10 and generate the avoidance path at the time when the serving robot 10 recognizes an obstacle while moving to the target point, or may acquire the current position of the serving robot 10 and generate the avoidance path after a preset time (for example, 10 seconds) has elapsed from the time when the serving robot 10 recognizes an obstacle while moving to the target point.

According to various embodiments of the present invention, the computing device 100 may control the serving robot 10 based on the area of the passage corresponding to the section on which the obstacle is recognized in operation (S130).

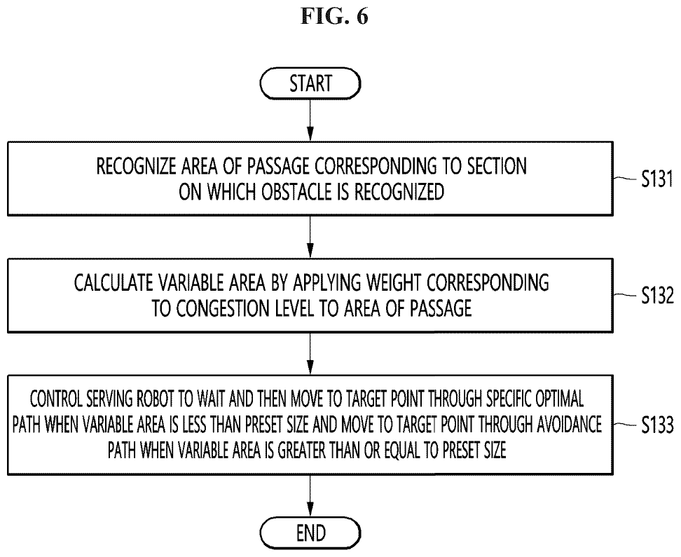

Specifically, referring to FIG. 6, the computing device 100 may recognize the area of the passage corresponding to the section on which the obstacle is recognized (S131).

For example, the computing device 100 may recognize the area of the passage corresponding to the position where the serving robot 10 recognizes the obstacle from the map information.

When the computing device 100 recognizes the area of the passage, the computing device 100 may apply a weight corresponding to the congestion level to the area of the passage to calculate a variable area (S132).

For example, assuming that the area of the passage is 10, when the congestion level is 1, the computing device 100 may apply a weight of 1 to calculate a variable area of 10. In addition, when the congestion level is 2, which is greater than 1, the computing device 100 may apply a weight of 0.9 to calculate a variable area of 9. In addition, when the congestion level is 3, which is greater than 2, the computing device 100 may apply a weight of 0.8 to calculate a variable area of 8.

The computing device 100 may control the serving robot 10 to wait and then move to the target point through the specific optimal path when the variable area is less than the preset size, and control the serving robot 10 to move to the target point through the avoidance path when the variable area is greater than or equal to the preset size (S133). Here, the preset size may be preset in response to the size of the area in which the plurality of serving robots may move smoothly. For example, the computing device 100 may set 3 times the area occupied by one serving robot 10 as the preset size, but is not limited thereto.

For example, the computing device 100 may control the serving robot 10 to wait and then move to the target point through the specific optimal path when the variable area is less than 8, and control the serving robot 10 to move to the target point through the avoidance path when the variable area is greater than or equal to 8.

According to various embodiments of the present invention, the computing device 100 may control the serving robot 10 based on the type of obstacle or whether the obstacle is moving in operation (S130).

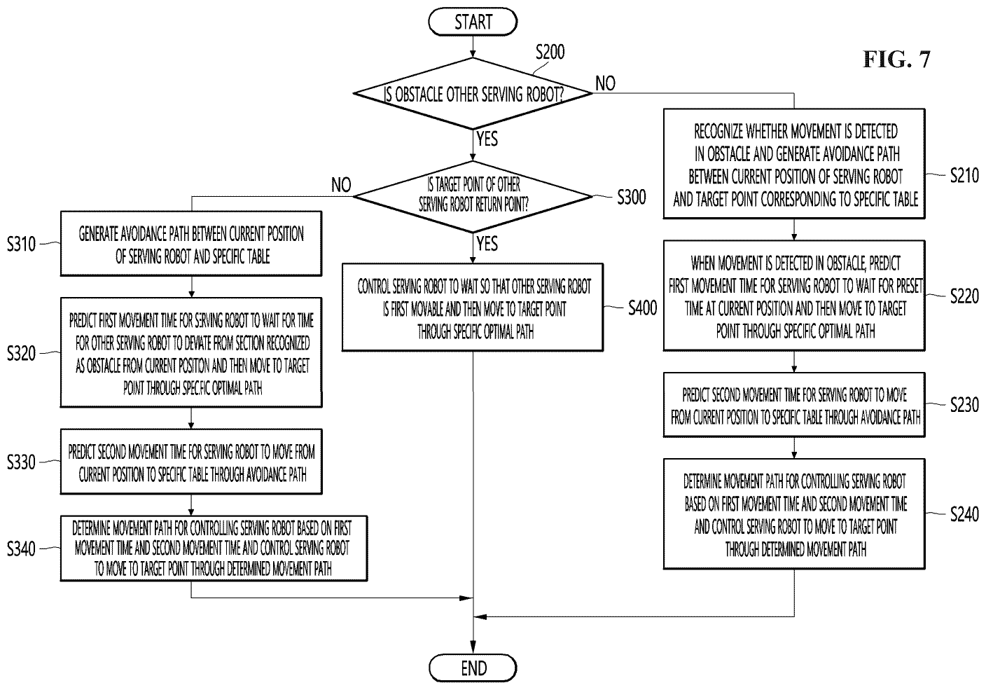

Specifically, referring to FIG. 7, the computing device 100 may recognize whether the obstacle recognized by the serving robot 10 is another serving robot (S200).

When the computing device 100 recognizes that the obstacle recognized by the serving robot 10 is another serving robot (S200, Yes), the computing device 100 may recognize whether a target point of the other serving robot is a return point (S300).

Meanwhile, when the computing device 100 recognizes that the obstacle recognized by the serving robot 10 is not another serving robot (S200, No), the computing device 100 may recognize whether the movement is detected in the obstacle and generate the avoidance path between the current position of the serving robot 10 and the target point corresponding to the specific table (S210).

For example, the computing device 100 may set the area where the obstacle is recognized in the space according to the map information as a no-movement area, and generate the avoidance path using a shortest path calculation algorithm.

When the movement is detected from the obstacle, the computing device 100 may predict a first movement time in which the serving robot 10 waits for a preset time (for example, 30 seconds) at the current position and then moves to the target point through the specific optimal path (S220). In addition, the computing device 100 may predict a second movement time in which the serving robot 10 moves from the current position to the specific table through the avoidance path (S230). In addition, the computing device 100 may determine a movement path for controlling the serving robot 10 based on the first movement time and the second movement time, and control the serving robot 10 to move to the target point through the determined movement path (S240).

Specifically, the computing device 100 may control the serving robot 10 to move to the target point through a path corresponding to a relatively shorter movement time among the first movement time and the second movement time.

That is, while the computing device 100 recognizes that the obstacle recognized by the serving robot 10 is not another serving robot, the computing device 100 may recognize an obstacle as a person when there is movement in the obstacle, and predict the first movement time in which the serving robot 10 waits for a preset time when the person is expected to move and moves to the target point through the initially provided specific optimal path. In addition, the computing device 100 may predict the second movement time in which the serving robot 10 moves to the target point through a newly provided avoidance path. In addition, the computing device 100 may compare the movement time through the specific optimal path including the waiting time and the movement time through the avoidance path, and control the serving robot 10 to move to a faster movable path.

In various embodiments, the computing device 100 may omit the process of predicting the first movement time and the second movement time when no movement is detected in the obstacle, in operation (S220). In addition, the computing device 100 may control the serving robot 10 to immediately move to the target point through the avoidance path.

That is, when there is no movement in the obstacle while the computing device 100 recognizes that the recognized obstacle is not another serving robot, the computing device 100 may recognize that the obstacle is not a person (e.g., the computing device 100 recognizes a user's belongings, clothes, etc., rather than a person) and determine that the obstacle will not move in a short period of time. Therefore, the computing device 100 may control the serving robot 10 to immediately move to the target point through the avoidance path.

Therefore, the computing device 100 of the present invention does not control the serving robot 10 recognizing an obstacle to immediately avoid the obstacle, but may wait for a certain period of time and then compare the time it takes to move along the existing path with the time it takes to move by immediately avoiding the obstacle, thereby controlling the serving robot 10 to avoid the obstacle while minimizing the serving time.

Referring back to operation (S300), the computing device 100 may recognize whether the target point of another serving robot is the return point (S300).

When the computing device 100 recognizes that the obstacle recognized by the serving robot 10 is another serving robot and that the target point of the other serving robot is the return point (S300, Yes), the computing device 100 may control the serving robot 10 so that the other serving robot moves preferentially and then moves to the target point through the specific optimal path.

That is, the computing device 100 may control the serving robot returning to the return point to move preferentially within the space in which the serving robot 10 performs serving, thereby reducing the congestion level of the space and maintaining a pleasant environment in the space.

Meanwhile, when the computing device 100 recognizes that the obstacle recognized by the serving robot 10 is another serving robot and the target point of the other serving robot is not the return point (S300, No), the computing device 100 may generate the avoidance path between the current position of the serving robot 10 and the specific table (S310).

For example, the computing device 100 may set the area where the obstacle (here, the other serving robot) is recognized in the space according to the map information as a no-movement area, and generate the avoidance path using the shortest path calculation algorithm.

In addition, the computing device 100 may predict the first movement time in which the serving robot 10 waits for the time for the other serving robot to deviate from the section recognized as the obstacle from the current position and then moves to the target point through the specific optimal path (S320). Here, the time for the other serving robot to deviate from the section recognized as the obstacle may be recognized based on the movement path transmitted by the computing device 100 to the other serving robot, or may be received by the computing device 100 from the other serving robot.

In addition, the computing device 100 may predict the second movement time in which the serving robot 10 moves from the current position to the specific table through the avoidance path (S330). In addition, the computing device 100 may determine the movement path for controlling the serving robot 10 based on the first movement time and the second movement time, and control the serving robot 10 to move to the target point through the determined movement path (S340).

Specifically, the computing device 100 may control the serving robot 10 to move to the target point through the path corresponding to the relatively shorter movement time among the first movement time and the second movement time.

That is, while the serving robot 10 recognizes that the obstacle recognized by the serving robot 10 is another serving robot, the computing device 100 may predict the first movement time in which the serving robot 10 waits for the preset time when the other serving robot is expected to move and then moves to the target point through the initially provided specific optimal path. In addition, the computing device 100 may predict the second movement time in which the serving robot 10 moves to the target point through a newly provided avoidance path. In addition, the computing device 100 may compare the movement time through the specific optimal path including the waiting time and the movement time through the avoidance path, and control the serving robot 10 to move to a faster movable path.

Therefore, the computing device 100 of the present invention may control the serving robot 10 to avoid the obstacle while increasing the serving efficiency (specifically, minimizing the serving time).

According to the present invention, by controlling a serving robot to move to a target point through a previously provided optimal path after waiting or by controlling the serving robot to move to the target point through a newly generated avoidance path depending on a situation in which the serving robot detects obstacles, it is possible to control the serving robot to avoid the obstacles while increasing the serving efficiency.

Effects of the present invention are not limited to the effects described above, and other effects that are not mentioned may be obviously understood by those skilled in the art from the following description.

Although exemplary embodiments of the present invention have been described with reference to the accompanying drawings, those skilled in the art will understand that various modifications and alterations may be made without departing from the spirit or essential features of the present invention. Therefore, it is to be understood that the exemplary embodiments described hereinabove are illustrative rather than being restrictive in all aspects.

What is claimed is:

1. A method of obstacle avoidance control of a serving robot, which is performed by a computing device including at least one processor, the method comprising:
generating optimal paths for each of a plurality of tables included in a space in which a serving robot performs serving based on map information on the space;
when serving for a specific table is set, transmitting a specific optimal path for moving to a target point corresponding to the specific table to the serving robot and controlling the serving robot to move to the target point through the specific optimal path; and
when the serving robot recognizes an obstacle while moving to the target point and stops moving, controlling the serving robot to wait and then move to the target point through the specific optimal path or move to the target point through an avoidance path.

2. The method of claim 1, wherein the generating of the optimal paths for each of the plurality of tables included in the space in which the serving robot performs serving based on the map information on the space includes generating one or more optimal paths corresponding to congestion levels for each of the plurality of tables according to one or more congestion levels, and
the one or more congestion levels are determined based on at least one of a current time, the number of orders placed in the space, and the number of people who have entered the space.

3. The method of claim 2, wherein, when the serving for the specific table is set, the transmitting of the specific optimal path for moving to the target point corresponding to the specific table to the serving robot and the controlling of the serving robot to move to the target point through the specific optimal path includes:
recognizing a current congestion level based on information on the number of orders and the number of people received from at least one of the serving robot, a user terminal, and an external server, and the current time; and
transmitting the specific optimal path corresponding to the current congestion level among one or more optimal paths for the specific table to the serving robot.

4. The method of claim 1, wherein, when the serving for the specific table is set, the transmitting of the specific optimal path for moving to the target point corresponding to the specific table to the serving robot and the controlling of the serving robot to move to the target point through the specific optimal path includes:
when there are two or more accessible target points on the specific table because at least two surfaces of the specific table are in contact with a passage, recognizing movement paths of other serving robots; and
controlling the serving robot to move to the target point through the specific optimal path that has a least overlapping path with the movement paths of the other serving robots among the optimal paths corresponding to each of the two or more target points.

5. The method of claim 2, wherein, when the serving robot recognizes the obstacle while moving to the target point and stops moving, the controlling of the serving robot to wait and then move to the target point through the specific optimal path or move to the target point through the avoidance path includes:
recognizing an area of a passage corresponding to a section on which the obstacle is recognized;
calculating a variable area by applying a weight corresponding to the congestion level to the area of the passage; and
controlling the serving robot to wait and then move to the target point through the specific optimal path when the variable area is less than a preset size and move to the target point through the avoidance path when the variable area is greater than or equal to the preset size.

6. The method of claim 1, wherein, when the serving robot recognizes the obstacle while moving to the target point and stops moving, the controlling of the serving robot to wait and then move to the target point through the specific optimal path or move to the target point through the avoidance path includes:
when the obstacle is the other serving robot, recognizing a target point of the other serving robot; and
when the target point of the other serving robot is a return point, controlling the serving robot to wait so that the other serving robot is first movable and then move to the target point through the specific optimal path.

7. The method of claim 1, wherein, when the serving robot recognizes the obstacle while moving to the target point and stops moving, the controlling of the serving robot to wait and then move to the target point through the specific optimal path or move to the target point through the avoidance path includes:
when the obstacle is the other serving robot, recognizing a table of the other serving robot;
when the target point of the other serving robot is not a return point, generating an avoidance path between a current position of the serving robot and the specific table;
predicting a first movement time for the serving robot to wait for a time for the other serving robot to deviate from a section recognized as the obstacle from the current position and then move to the target point through the specific optimal path;
predicting a second movement time for the serving robot to move from the current position to the specific table through the avoidance path; and
determining a movement path for controlling the serving robot based on the first movement time and the second movement time and controlling the serving robot to move to the target point through the determined movement path.

8. The method of claim 1, wherein, when the serving robot recognizes the obstacle while moving to the target point and stops moving, the controlling of the serving robot to wait and then move to the target point through the specific optimal path or move to the target point through the avoidance path includes:
when the obstacle is not another serving robot, recognizing whether movement is detected in the obstacle and generating an avoidance path between a current position of the serving robot and a target point corresponding to the specific table;
when movement is detected in the obstacle, predicting a first movement time for the serving robot to wait for a preset time at the current position and then move to the target point through the specific optimal path;
predicting a second movement time for the serving robot to move from the current position to the specific table through the avoidance path; and
determining a movement path for controlling the serving robot based on the first movement time and the second movement time and controlling the serving robot to move to the target point through the determined movement path.

9. An apparatus comprising:
a memory configured to store one or more instructions; and
a processor configured to execute the one or more instructions stored in the memory,
wherein the processor performs the method of claim 1 by executing the one or more instructions.

10. A computer program stored in a computer-readable recording medium on which a program for executing a method of obstacle avoidance control of a serving robot with a computing device is recorded, wherein the method comprises:
generating optimal paths for each of a plurality of tables included in a space in which a serving robot performs serving based on map information on the space;
when serving for a specific table is set, transmitting a specific optimal path for moving to a target point corresponding to the specific table to the serving robot and controlling the serving robot to move to the target point through the specific optimal path; and
when the serving robot recognizes an obstacle while moving to the target point and stops moving, controlling the serving robot to wait and then move to the target point through the specific optimal path or move to the target point through an avoidance path.
